(19) United States
(12) Patent Application Publication
(10) Pub. No.: US 2023/0289778 A1
(43) Pub. Date: Sep. 14, 2023

(54) SYSTEM AND METHOD TO FACILITATE NON-FUNGIBLE TOKENS (NFT)

(71) Applicant: Kyle Sponable, Salisbury, NC (US)

(72) Inventor: Kyle Sponable, Salisbury, NC (US)

(21) Appl. No.: 18/107,177

(22) Filed: Feb. 8, 2023

Related U.S. Application Data
(60) Provisional application No. 63/319,553, filed on Mar. 14, 2022.

(51) Int. Cl. G06Q 20/36; G06Q 20/38; G06Q 20/12

(52) U.S. Cl. CPC G06Q 20/3672; G06Q 20/389; G06Q 20/1235; G06Q 20/3827

(57) ABSTRACT

A system and method to facilitate creation and management of Non-Fungible Tokens (NFTs) are disclosed. In one embodiment, the system includes a node for receiving an NFT generated by a hosting provider. The system further includes a wallet attached to the node to hold the NFT. The system also includes a smart contract to manage the wallet attached to the node, wherein the smart contract allows for or enables different actions relating to the NFT based on a blockchain on which the NFT is implemented. Furthermore, the system a broker that is allowed by the hosting provider to sell or resell the NFT to a consumer.

### CROSS-REFERENCE TO RELATED APPLICATIONS

The present Application claims the benefit of U.S. Provisional Patent Application Ser. No. 63/319,553 filed on Mar. 14, 2022, the entire disclosure of which is incorporated herein in its entirety by reference.

### FIELD

This disclosure generally relates to support and/or usage of a Non-Fungible Tokens (NFT), and more particularly, to a system and method to facilitate creation and management of NFTs.

### BACKGROUND

Non-fungible tokens, like Bitcoin and other cryptocurrency, are assets hosted on blockchain, which is a public ledger that records transactions. NFTs are different from fungible tokens like Bitcoin and other cryptocurrency in that NFTs are unique assets that cannot be interchanged or divided. Fungible tokens like cryptocurrency can be exchanged with other cryptocurrency because one Bitcoin (or other cryptocurrency) has the same exact value as another Bitcoin. NFTs, on the other hand, are more like trading cards. Each NFT is something completely different from another NFT. For example, NFTs can be anything digital such as digital art or music.

Therefore, there is need for a novel system and method for creating, managing, and monetizing digital assets such as NFTs.

### SUMMARY

A system and method to facilitate creation and management of Non-Fungible Tokens (NFTs) are disclosed. In one embodiment, the system includes a node for receiving an NFT generated by a hosting provider. The system further includes a wallet attached to the node to hold the NFT. The system also includes a smart contract to manage the wallet attached to the node, wherein the smart contract allows for or enables different actions relating to the NFT based on a blockchain on which the NFT is implemented. Furthermore, the system a broker that is allowed by the hosting provider to sell or resell the NFT to a consumer.

### BRIEF DESCRIPTION OF THE DRAWINGS

FIG. 1 illustrates various layers involved in the creation and management of a blockchain according to an exemplary embodiment.

FIG. 2 illustrates various components involved in the creation and management of NFTs using the Consortia NFT system according to an exemplary embodiment.

FIG. 3 illustrates actions that could be performed by various components in the Consortia NFT system according to an exemplary embodiment.

FIG. 4 is a block diagram according of an exemplary embodiment.

FIG. 5 is a diagram illustrating a Heartbeat High Availability (HA) system according of an exemplary embodiment.

FIG. 6 is a block diagram according of an exemplary embodiment.

FIG. 7 shows information contained in a packet information according to an exemplary embodiment.

FIG. 8 illustrates the independent command and control operations of the nodes and clusters according to one exemplary embodiment.

### DESCRIPTION

The creation and publishing of websites, and the sub-contracted management of webhosting has been a staple of online life since Web 1.0. The proliferation of systems like cPanel removed the technical challenges inherent in the management which paved the way for wide adoption of the burgeoning web. As of now, the actual management of Web 3.0 validation nodes requires technical prowess well above those of the average user.

One or multiple of following terms may be used hereafter:
Daemon—A software process that runs continually on a server and reacts to outside stimuli.
dApp—An application that runs on Web3.
Host—The digital entity on which the Validator node software is hosted.
Hosting—The physical infrastructure on which web or blockchain infrastructure exists
NFT—Non-Fungible Token is a unique digital identifier that cannot be copied, substituted, or subdivided, that is recorded in a blockchain, and that is used to certify authenticity and ownership (as of a specific digital asset and specific rights relating to it). In one embodiment, an NFT could be any token or entity replacing the functionality of a token on the blockchain.
Validator Node (Validator)—The physical software that a blockchain uses to add transactions to the blockchain and generate rewards
Smart Contract—A piece of software deployed on a blockchain that runs when certain conditions are met
Reward—Compensation by the blockchain to the operators of relevant nodes

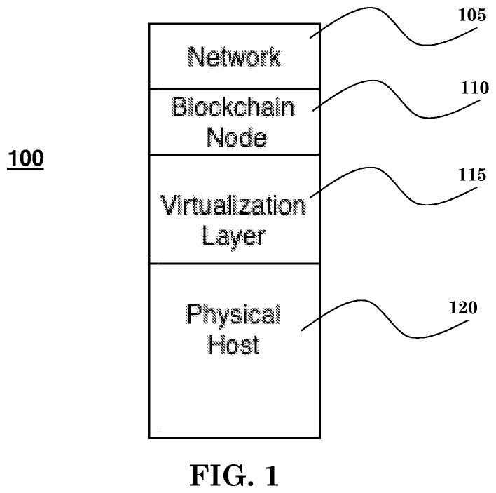

FIG. 1 illustrates various layers 100 (including network 105, blockchain node 110, virtualization layer 115, and physical host 120) involved in the creation and management of a blockchain according to an exemplary embodiment. To create a validation node on the blockchain, one first creates and initializes a wallet compatible with the blockchain, deposits a sum of tokens into the wallet, then must secure redundant and secure application hosting, maintain that installation, and ensure that the installation always meets or exceeds the security considerations. The would-be investor is also saddled with the responsibility of troubleshooting the node if there is an issue.

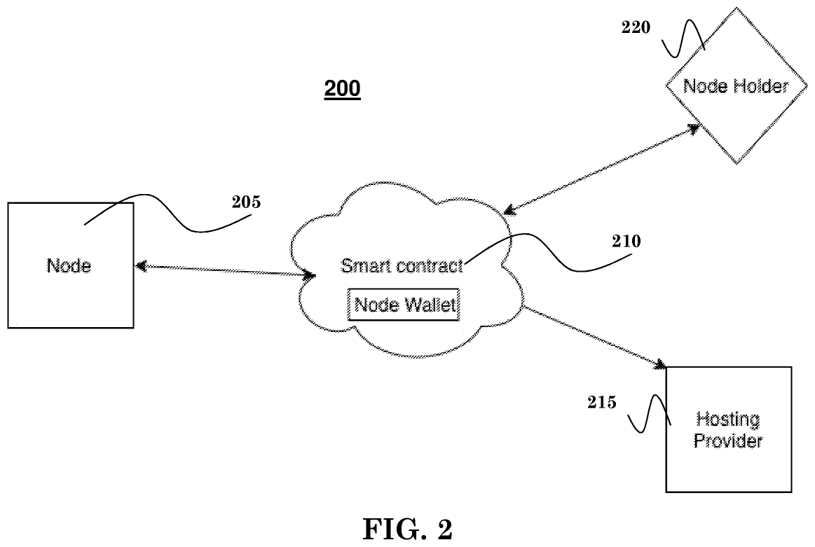

FIG. 2 illustrates various components involved in the creation and management of NFTs using the inventive NFT system 200 (a.k.a. the Consortia NFT system) according to an exemplary embodiment. While utilizing the Consortia Management NFT system 200, the node (or node owner) 205 receives an NFT generated by the hosting provider or organization 215. The node owner 205 then logs into a decentralized application (dApp) which verifies ownership of the NFT which then actions the vote, or other instructions of the node holder 220. The way the NFT enacts control is via a smart contract which manages the wallet attached to the node 205. The smart contract 210 allows for different actions based on the blockchain the NFT is to be implemented on and the terms under which the NFT buyer purchased the NFT. The actions could include voting, delegating voting rights, setting reward and commission percentages, and/or completing administrative tasks. Rewards are paid to the hosting provider 215 and the NFT holder 205 based on the terms of service under which the hosting provider 215 determines.

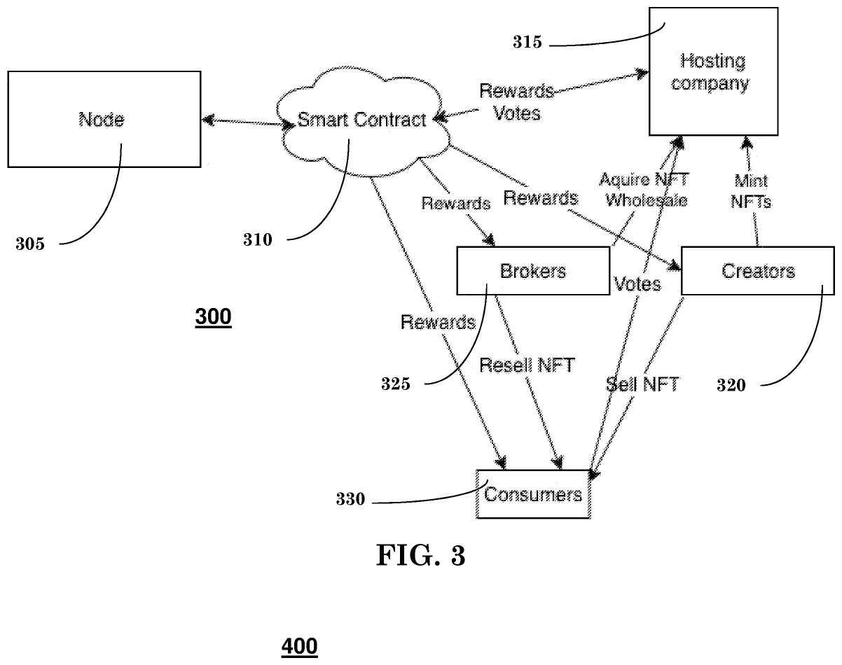

FIG. 3 illustrates actions that could be performed by various components in the inventive NFT system 300 (a.k.a. the Consortia NFT system) according to an exemplary embodiment. The Consortia NFT system 300 also allows for brokers 305 or independent creators 310 to resell NFTs and/or to offer Web3.0 products backed by the staking rewards and the hosting providers network using the same NFT management technique described. The hosting provider or company 315 could delegate rewards, privileges and create other packages as desired by manipulating the smart contract at time of deployment, and could then allow others to act as brokers or create new products on top of the Consortia NFT system 300. In one embodiment, the hosting provider 315 could sell NFTs and other products directly to the end consumers 330 at its discretion without needing any third parties. In addition, the hosting provider 315 could act as the artist/creator 320 and could mint artist NFTs if it so chooses.

The Node Owners/NFT Holders (Shown as Element 305 in FIG. 3)
Receive rewards pro-rated with the hosting fees automatically
Transmit voting and other messages using the on-chain validation
Transfer these rights in accordance with the NFT
Create new NFTs that can be handed to others to delegate node control duties
   These duties are
      Receipt of funds both partial and in total
      Delegate voting duties
         Are temporarily delegated to a separate party from the broker
         Allow the broker rights as required
   These NFTs must have the following characteristics:
      Revokable by both the Node owner and Hosting NFT holder
      Time bound—this limit settable by host NFT holder
      The broker NFT may not be deleted by the NFT holder
Manage delegations and reward amounts
The Node Owner/NFT Holder 305 can attach one or multiple nodes to a single run of NFTs or can do one node per run to an NFT
In one embodiment, the Node Owner/NFT Holder 305 could sell NFTs and other products directly to the end consumers 330 at its discretion without needing any third parties

NFT Brokers (Shown as Element 325 in FIG. 3)
See all clients NFTs
Manage clients' votes and issue delegation NFTs
Receive rewards

NFT Artists/Creators (Shown as Element 320 in FIG. 3)
Mint and issue NFTs
Set NFT payment percentages from node
Receive rewards
In one embodiment, the hosting provider 315 could act as the artist/creator 320 and could mint artist NFTs if it so chooses

The Hosting Company NFT Holders (Shown as Element 315 in FIG. 3)
Receive the prorated portion of the hosting rewards automatically
Vote if no message from the Node owner is received. This should be manual and done as needed and not automatic
Be able to validate messages are sent from the Node Owner NFT Holder
Dissolve the node and liquidate the wallet
In one embodiment, the hosting provider 315 could sell NFTs and other products directly to the end consumers 330 at its discretion without needing any third parties
In one embodiment, The Hosting Company/Provider can intercept payments as ordered by the government or other regulatory authority during the execution of the smart contract. Minor alterations to the system may be required to adapt it to ongoing compliance requirements.

The Smart Contract Controlling the Nodes' Wallet (Shown as Element 310 in FIG. 3)
Will contain functions to create a new wallet if needed for if the node needs to be reinitialized
Any function may be managed using the hosting company NFT
Deployable via automated means
When deployed create and send the Node Owner NFT and Hosting NFT to the correct wallets
Be built to be upgraded
Interact with and manipulate the blockchains dApp to manage the dApp functions

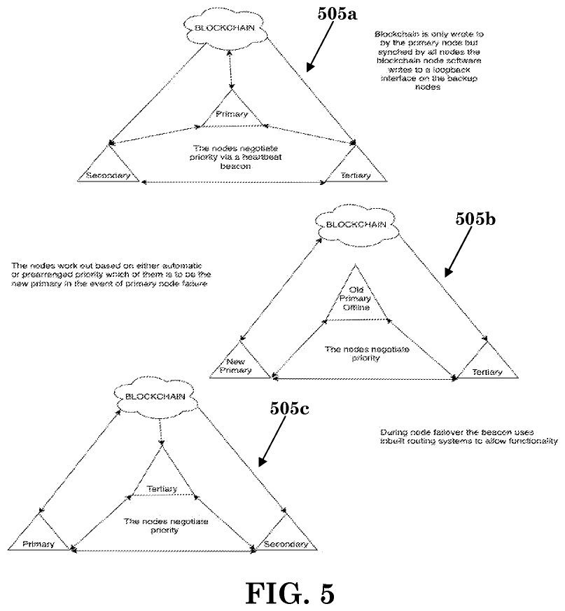

In general, the inventive Heartbeat High Availability (HA) mechanism/system (shown as element 500 in FIG. 5) is a platform indifferent, blockchain blind clustering technology designed to allow for true 100% uptime without the need for cloud providers or the need for extremely complicated local clustering and redundant networking. The intent behind blockchain is the decentralization of not only ownership of network assets, but the decentralization of command and control (C&C) as well as geographical separation of mission critical infrastructure.

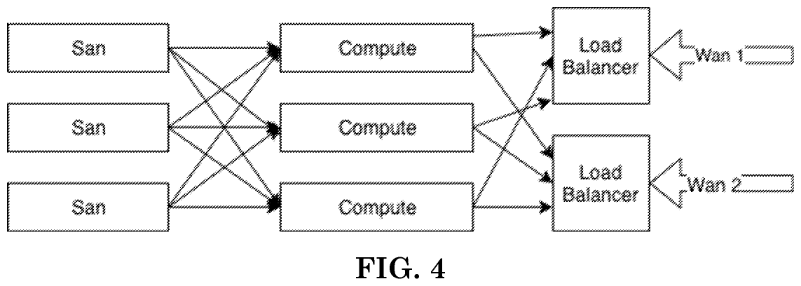

FIG. 4 is a block diagram 400 according of an exemplary embodiment. The existing technologies either require use of expensive proprietary solutions like VMWare, or open source and complicated clusters such as oVirt, or the use of Amazon's cloud offering AWS, or its competitors. This leads to requiring extensive systems and network engineering expertise or being totally reliant on a cloud provider for uptime. Neither of which is conducive to the aims of a decentralized web.

FIG. 5 is a diagram illustrating a Heartbeat HA system 500 according of an exemplary embodiment. In the Heartbeat HA system, the blockchain software runs and is configured per the manufacturer or originating project's standard procedures. Each host in the cluster 505a, 505b, and 505c has a heartbeat daemon (not shown in FIG. 5) that listens for traffic and broadcasts to the other hosts in the cluster. The hosts authenticate the heartbeat by verifying the hash against the ones in the known list and then ranking choice based on uptime and configured priority number. The daemons determine the host with the smallest score is primary and interfaces with the blockchain, the others use the hosts operating system firewall functionality to drop outgoing packets originated by the blockchain software. The net effect is there are clones of the validation node set on hot standby ready to assume primary function transparent to the originating blockchain.

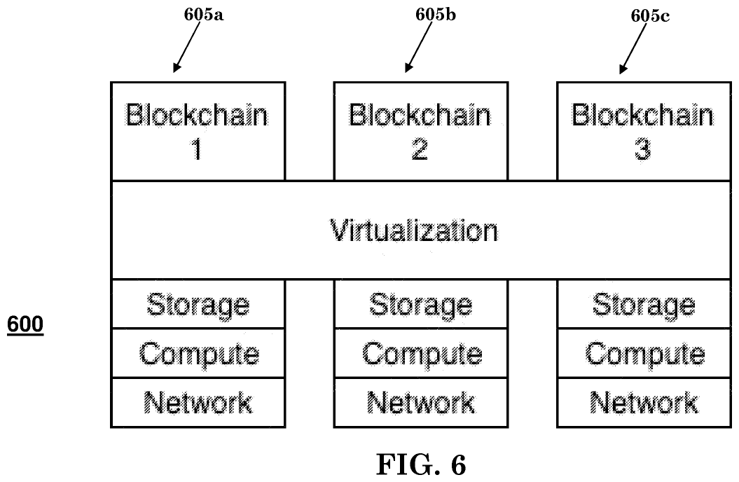

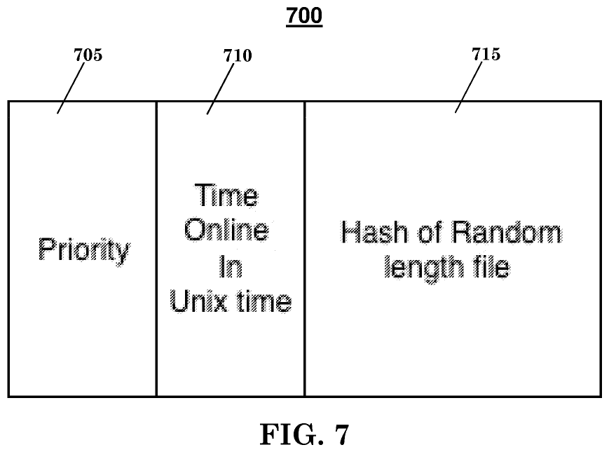

As shown in FIG. 6, on a physical level, a cluster 600 is made up of several geographically separated physical computing clusters 605a, 605b, and 605c of standard hardware running multiple types of blockchain nodes owned by multiple clients, as shown in FIG. 6. The Heartbeat HA protocol contains priority packets with priority information via a standard TCP/IP connection, as shown in FIG. 7. The information in a priority packet 700 includes: (1) the packet's priority number 705, (2) the time (e.g., in Unix time) 710 that the server first came online, and (3) a hash of random length file 715 filled with random characters to verify authenticity.

The priority of the primary node will be mathematically determined by the following formula applied to all data stored from the various heartbeat nodes. State will be maintained via standard persistence mechanisms and archived from memory at regular intervals

Whereas

| P | Priority |
|---|---|
| Ps | Priority |
| | Score |
| N1 | Time online |
| | of Node 1 |
| | in Unix time |
| N2 | Time online |
| | of Node 2 |
| | in Unix time |
| 1 | 1 |
| 2 | 2 |
| 3 | 3 |

The Heartbeat daemon is generally a piece of software with the following characteristics:

### API Functions

### Post:

Post the heartbeat protocol to the other hosts in the cluster

### Listen:

Listen for heartbeat traffic and maintain state of the nodes based on TCP methodology

### Get:

Health information if secondary or tertiary

### Compute Functions

Calculate the numerical priority of the incoming traffic
Interface with the underlying operating system firewall rules
If ranked secondary or tertiary closely monitor the status of the higher priority node
Assume new role in cluster as needed

### Configuration/Stored Items

Status of node whether primary secondary tertiary
Maintain the state of other nodes in the cluster
DNS information for other nodes in the cluster

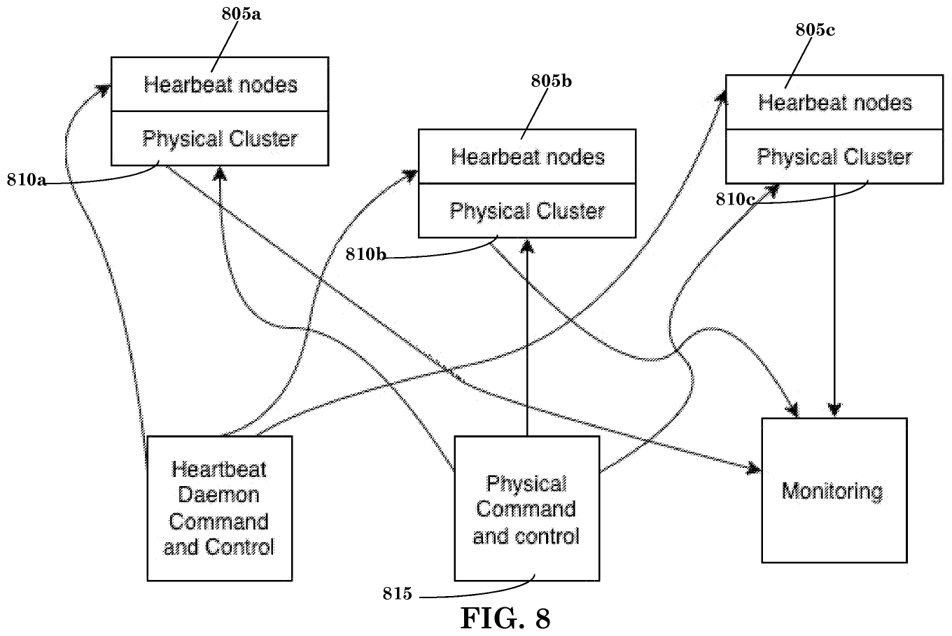

FIG. 8 illustrates the independent command and control operations of the heartbeat nodes 805a, 805b, and 805c and physical clusters 810a, 810b, and 810c according to one exemplary embodiment. The command-and-control function is accomplished via shared cryptographic key from a standalone command and control node 815, which uses industry standard orchestration technology to send commands and software updates to the corresponding nodes. The command and control node 815 verifies node status by receiving heartbeat packets from the heartbeat nodes 805a, 805b, and 805c. The nodes 805a, 805b, and 805c and clusters 810a, 810b, and 810c are designed to operate independently of command and control for a long period of time.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A system to facilitate creation and management of Non-Fungible Tokens (NFTs), comprising:
a node for receiving an NFT generated by a hosting provider;
a wallet attached to the node to hold the NFT;
a smart contract to manage the wallet attached to the node, wherein the smart contract allows for or enables different actions relating to the NFT based on a blockchain on which the NFT is implemented; and
a broker that is allowed by the hosting provider to sell or resell the NFT to a consumer.

2. The system of claim 1, wherein the hosting provider is capable of delegating rewards and/or privileges, and creating NFT-based packages as desired by manipulating the smart contract at the time of deployment.

3. The system of claim 1, wherein the hosting provider is capable of minting Non-Fungible Tokens (NFTs).

4. The system of claim 1, wherein the hosting provider is capable of selling or reselling the NFT directly to the consumer.

5. The system of claim 1, wherein the node is capable of selling or reselling the NFT directly to the consumer.

6. The system of claim 1, wherein the blockchain has a host which runs a daemon process that listens for traffic and broadcasts a priority packet to other hosts in the blockchain,
wherein the priority packet contains a priority value, a time online which is a time that a server first came online, and a hash value, and
wherein the other hosts use the hash value for authentication, and determine a priority ranking based on the priority value and the time online.

7. The system of claim 1, wherein the time online is represented in Unix time.

8. The system of claim 1, wherein the priority ranking includes primary, secondary, and/or tertiary.
